(19) United States
(12) Patent Application Publication
(10) Pub. No.: US 2026/0001762 A1
(43) Pub. Date: Jan. 1, 2026

(54) NITRIC ACID PRODUCTION WITH OXYGEN SUPPLY TO ABSORPTION SECTION

(71) Applicant: Stamicarbon B.V., Sittard (NL)

(72) Inventors: Maria Paz MUÑOZ LÓPEZ, Sittard (NL); Carmen PÉREZ SALMERÓN, Sittard (NL); Martinus VOORWINDEN, Sittard (NL)

(73) Assignee: Stamicarbon B.V., Sittard (NL)

(21) Appl. No.: 19/107,863

(22) PCT Filed: Jul. 29, 2024
(86) PCT No.: PCT/NL2024/050421

§ 371 Date: Feb. 28, 2025

(30) Foreign Application Priority Data
Jul. 28, 2023 (EP) 23188493.3

(51) Int. Cl. C01B 21/40; C01C 1/04; C25B 1/04; C25B 15/08

(52) U.S. Cl. CPC C01B 21/40; C01C 1/0405; C25B 1/04; C25B 15/081

(57) ABSTRACT

The disclosure pertains to a nitric acid production process and plant wherein tail gas is recycled to the burner and O₂ is supplied to the absorption section in a certain molar ratio to the ammonia feed.

### FIELD

The invention pertains to the production of nitric acid.

### INTRODUCTION

The invention pertains to the production of nitric acid (NA) by the catalysed reaction of NH₃ with O₂; in particular with the Ostwald process.

Ullmann's Encyclopedia of Industrial Chemistry, chapter Nitric Acid, Nitrous Acid and Nitrogen Oxides, 2012, provides a general discussion of plants and processes for this type of nitric acid production.

NA production of this type involves three chemical steps: catalytic reaction of ammonia with O₂ to yield NO, oxidation of the NO product to NO₂ and absorption of the nitrogen oxides in water to yield nitric acid as a liquid stream, and a tail gas. Existing processes typically use ammonia-air mixtures for the catalytic oxidation (combustion) of NH₃.

A nitric acid plant typically comprises a burner section comprising an ammonia oxidation catalyst, a cooling/condensation section, an absorption section with a liquid outlet for the nitric acid stream and a gas outlet for the tail gas. The absorption section typically is provided as an absorption column. Raw nitric acid from the absorption section is typically supplied to a bleacher. In existing plants, NOx dissolved in the acid is stripped out with secondary air in the bleacher. The gas from the bleacher is fed to the absorption column, in particular to the bottom of the absorption column, and provides O₂ that is necessary for NO oxidation in the absorption column.

A challenge is that the tail gas from the absorber contains nitrogen oxides (NOx), and N₂O, and venting this gas stream is environmentally not desirable. In the absorption column, NO is constantly formed and this prevents complete absorption of the inlet gases respectively having tail gas at the absorption column outlet that is completely free of NOx and N₂O. Typically, a cleaning treatment of the tail gas to remove the NOx is necessary. Various approaches to reduce tail gas NOx levels are used in practice, such as improved absorption, chemical scrubbing, adsorption, and catalytic tail gas reduction (see e.g. Ullmann's Nitric Acid, para. 1.4.2.3). However, meeting the modern stringent environmental restrictions on NOx emissions remains challenging. The tail gas treatment also increases capital expenditure (equipment costs) and operation expenses of the plant and process. For example, a longer absorption column is necessary, or two absorption columns in series. Ullmann's Nitric Acid, para. 1.4.2.3 mentions that in an already existing nitric acid plant, the options to reduce tail gas NOx levels at the absorber outlet are to expand the absorption volume and/or lower the absorption temperature. In the first approach, large additional volumes only result in small reductions of tail-gas NOx levels because the oxidation of nitrogen monoxide to nitrogen dioxide proceeds very slowly when the NOx concentration is low. The drawback to this method is that added absorption volume in stainless steel is very expensive.

There is furthermore generally a desire to reduce CO2 emissions in the chemical industry, also for NH₃ production including H₂ feedstock production (‘green hydrogen’).

WO 2023/287294 describes nitric acid production wherein an oxygen gas stream comprising at least 90 vol. % O₂ and ammonia feedstock are provided to a burner section; and a first part of the tail gas stream is heated in a tail gas heating section to give a heated tail gas stream and supplied to the burner section.

U.S. Pat. No. 3,927,182 A describes a nitric acid production process wherein a part of an absorber tail gas is mixed with O₂-containing gas and supplied to a converter instead of air.

CN 109516445 A describes a nitric acid production process wherein an O₂ stream originating from an air separation is supplied to an ammonia oxidation furnace and an O₂ stream originating from water electrolysis separation is supplied to a bleaching tower. In said process a tail gas from an absorber is supplied to the ammonia oxidation furnace.

There remains a desire for improved nitric acid production plants and processes. For instance, it is desired to provide nitric acid production plants and processes with improved NOx absorption.

### SUMMARY

Aspects of the invention aim to provide a nitric acid plant and process with improved operation of the absorption section and low NOx emissions.

The invention pertains in a first aspect to a process for the production of nitric acid comprising: supplying NH₃ feed to a burner section and reacting NH₃ and O₂ in the burner section to form a process gas stream; supplying the process gas stream from the burner section to an absorption section and contacting the process gas stream with an aqueous liquid in the absorption section to form a nitric acid stream and a tail gas stream; supplying a part, preferably at least 90 vol. %, of the tail gas stream from a tail gas outlet of the absorption section to the burner section, wherein A) O₂ (the absorption section O₂ feed) is introduced into the process gas stream between the burner section and the tail gas outlet of the absorption section in a molar ratio to the NH₃ feed of at least 1.0, preferably at least 1.20, or at least 1.50, or at least 1.90; and/or B) the tail gas at the tail gas outlet contains O₂ in a molar ratio to the NH₃ feed of at least 1.0, preferably at least 1.20, or at least 1.50, or at least 1.90. All preferences and details, also as set out in the dependent claims, apply independently for condition A, condition B, and the embodiment with features A and B in combination. Features A and B can be used independently and in combination.

Also provided is a nitric acid plant comprising a nitric acid production section and an ammonia production section, wherein the nitric acid production section comprises: a burner section comprising an inlet for an NH₃ feed, an inlet for a tail gas stream and an outlet for a process gas stream; an absorption section comprising an inlet connected to receive gas from the outlet for the process gas stream of the burner section, an inlet for an aqueous liquid, an outlet for the tail gas stream, and an outlet for a nitric acid stream. The ammonia production section comprises: a H₂O electrolysis unit comprising an inlet for a H₂O stream, a first outlet for a first O₂ stream and an outlet for a H₂ stream; an air separation unit comprising an inlet for an air stream, a second outlet for a second O₂ stream and an outlet for an N₂ stream; and an ammonia production unit comprising an inlet for the H₂ stream in fluid connection with the outlet for the H₂ stream from the H₂O electrolysis unit, an inlet for the N₂ stream in fluid connection with the outlet for N₂ stream from the air separation unit, and an outlet for an NH₃ stream. The plant preferably comprises a first gas flow line from the outlet of the burner section for the process gas stream to the outlet of the absorption section for the tail gas stream, and wherein the first outlet for the first O₂ stream and the second outlet for the second O₂ stream are both connected to the first gas flow line.

Also provided is a method of modifying an existing nitric acid plant wherein the method involves connecting both the first outlet for the first O₂ stream and the second outlet for the second O₂ stream to the first gas flow line; wherein the method preferably provides an inventive plant.

The disclosure hence pertains to a nitric acid production process and plant wherein O₂ is supplied to the absorption section in a certain ratio to the ammonia feed.

### BRIEF DESCRIPTION OF THE DRAWINGS

FIG. 1 schematically illustrates an example of a nitric acid production process and a plant according to the invention.

FIG. 2 schematically illustrates an example of a nitric acid production process and a plant according to the invention.

FIG. 3 schematically illustrates details of a part of an example process scheme.

Any embodiments illustrated in the figures are examples only and do not limit the invention.

### DETAILED DESCRIPTION

The invention pertains to a nitric acid production process wherein an NH₃ feed is supplied to a burner section and NH₃ and O₂ are reacted in the burner section giving a process gas, and the process gas is supplied to an absorption section. In the absorption section, the process gas is contacted with an aqueous liquid to form a nitric acid stream and a tail gas stream. The tail gas stream is supplied for at least a part, highly preferably for at least 90 vol. %, from a tail gas outlet of the absorption section to the burner section. Accordingly, the process gas stream and tail gas stream form a circulating gas stream.

In the invention, (A), oxygen (O₂) is introduced into the process gas stream between the burner section and the tail gas outlet of the absorption section in a molar ratio to the NH₃ feed of at least 1.0, preferably at least 1.20, or at least 1.50, or at least 1.90; typically up to 2.0. Hence, O₂ is introduced into the process gas stream between the gas outlet of the burner section and the tail gas outlet of the absorption section in a ratio to the NH₃ feed of at least 1.0, preferably at least 1.20, or at least 1.50, or at least 1.90 based on molar hourly amount (mol/hr). This oxygen can be referred to as the absorption section O₂ feed and can be introduced into the process gas as one or more gas streams. If the absorption section O₂ feed is provided as a plurality of gas streams, the gas streams in total should contain the specified amount of O₂.

Additionally or alternatively to feature (A), the oxygen amount may be specified by the feature that (B) the tail gas at the tail gas outlet of the absorption section contains O₂ in a molar ratio to the NH₃ feed of at least 1.0, preferably at least 1.20, or at least 1.50, or at least 1.90; typically up to 2.0.

The absorption section receives in addition to this absorption section O₂ feed any O₂ present in the process gas at the outlet of the burner. The process involves combining the absorption section O₂ feed with the process gas between the gas outlet of the burner section and the tail gas outlet of the absorption section. This involves combining or joining one or more gas streams providing the absorption section O₂ feed with the process gas. Hence, one or more gas streams providing the absorption section O₂ feed and the process gas stream are provided as separate gas streams which are combined. Accordingly, the absorption section O₂ feed is introduced into the gas flow line from the gas outlet of the burner section and the tail gas outlet of the absorption section; e.g. directly to the absorption column, and optionally through the bleacher. This gas flow line is in part provided by the absorption section and in part by one or more gas transport elements such as tubes and pipes and/or one or more sections such as a cooling section and a condensation section through which the process gas passes. In other words, the gas flow line, as used in the present disclosure, pertains to the combination of one or more units, which include the absorption section, and the gas transport elements between them.

The absorption section O₂ feed generally contains less than 80 vol. % N₂, in particular e.g. less than 40 vol. % or less than 10 vol. % N₂ or less than 2 vol. % N₂ or less than 1.0 vol. % N₂. If the absorption section O₂ feed is provided a plurality of gas streams, the gas streams in total should meet the maximum N₂ level. The N₂ level can additionally or alternatively be specified in that in the process, N₂ is introduced into the process gas between the gas outlet of the burner section and the tail gas outlet of the absorption section in a molar ratio to the NH₃ feed in the range 0 to less than 4.0, preferably in the range 0-2 or 0-1.0 or 0-0.2 or even 0-0.1. In some embodiments, no N₂ is introduced into the process gas or only negligible trace amounts contained in the absorption section O₂ feed. Some N₂ may be formed as a side product in the process gas in the burner section; this N₂ side product is not part of the absorption section O₂ feed as it is not introduced into the process gas stream. In a preferred embodiment, the tail gas stream and process gas stream together form a circulating gas stream and N₂ is introduced into the circulating gas stream in a molar ratio to the NH₃ feed in the range in the range of 0-0.2, preferably in the range 0-0.1. In a preferred embodiment, the tail gas stream and process gas stream together form a circulating gas stream and inert gas, e.g. N₂, is introduced into the circulating gas stream in a molar ratio to the NH₃ feed in the range in the range of 0-0.2, preferably in the range 0-0.1. Herein, inert gas indicates gas that must be purged to avoid accumulation. The term ‘introduced’ indicates supply from an external source. In practical terms, the NH₃ and/or O₂ feed streams will usually contain some traces of inert gases including N₂ and the molar ratio is e.g. above 1 ppm molar.

The specified molar ratio of the absorption section O₂ feed is well above the stoichiometric amount of O₂ for the absorption section on the basis of reaction (A) that, without wishing to be bound by way of theory, occurs in the absorption section:

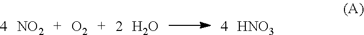

In the burner, reaction (I) takes place:

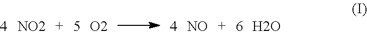

When the process gas is cooled, reaction (II) takes place:

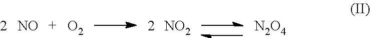

Upon absorption of the nitrogen oxides in liquid water, nitric acid is formed according to reactions (III) and (IV):

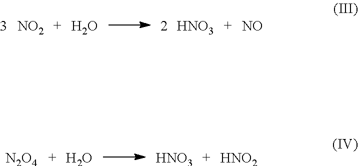

Without wishing to be bound by way of theory, per 4 molecules NH₃ converted to HNO₃, 5 molecules O₂ are reacted in reaction (I), 2 molecules O₂ in reaction (II) and 1 molecule O₂ in the absorber according to reaction (A); such that the stoichiometric O₂/NH₃ ratio is 2 for the total conversion. Taking into account that some NH₃ feed reacts to side products including N₂, the molar ratio feed O₂/NH₃ feed is typically below 2, e.g. in the range 1.9 to 2.0. In the inventive process, considering the purge of a part of the tail gas, the ratio O₂ feed/nitric acid is e.g. slightly above 2.0, e.g. up to 2.1.

The invention is based on the judicious insight of supplying a relatively large amount of O₂ to the absorption section without introducing large amounts of N₂ into the process. In particular, the relatively large amount of O₂ is super-stoichiometric with respect to the O₂-consuming reaction in the absorption section.

The absorption section, for example, receives at least 200% of the amount of O₂ necessary for reaction A, on the basis of the complete conversion of NH₃ to NO₂ between an inlet of the burner and a tail gas outlet of the absorption section.

It is observed that in the inventive approach, the NOx concentration in the absorption section is lower than in a process wherein O₂ is supplied in a stoichiometric amount on the basis of the same O₂ concentration of the absorption section O₂ feed. Nevertheless, an improved operation of the absorption section is achieved in the present invention. Furthermore, in a reference plant with secondary air supply to the absorption section, an amount of secondary air corresponding to an excess of oxygen with respect to reaction (A) implies an extensive tail gas treatment, which is a disadvantage. In the present invention this is avoided.

In the inventive process, the concentration of O₂ respectively N₂ in the tail gas stream is, for instance, substantially the same as in air. This advantageously allows for performing ammonia oxidation (I) in the burner section with the tail gas recycle in a similar manner as in a reference plant using air supply to the burner. Preferably, at least 90 mol. % of the N₂ received by the burner section originates from the burner gas outlet, more preferably at least 95 vol. %, or even all.

Preferably, at least 90 mol. % of the O₂ received by the burner section originates from the tail gas outlet of the absorption section, more preferably at least 95 vol. %, or even all. Preferably, the burner section receives O₂ in a molar ratio to NH₃ of at least 1.90 and/or up to 2.0.

In a reference process, the burner receives both an oxygen-rich gas and a part of the tail gas, with in the reference process a lower molar fraction of the O₂ feed of the burner supplied by recycled tail gas than in embodiments of the present invention. The reference process correspondingly has a lower molar ratio of O₂ in the tail gas to NH₃ feed of the burner than in feature B of the present disclosure, and accordingly the reference process also has a lower absorption section O₂ feed to NH₃ feed molar ratio than in feature A of the present disclosure. An advantage of supplying a large part of the oxygen feed of the burner as part of the tail gas, is that more efficient heat recovery is possible than in the reference process: the tail gas is heated by heat recovery to have at the burner inlet the appropriate temperature, such than when mixed with (relatively cold) ammonia feed the burner operates at a correct temperature. Compared to a the reference process where tail gas is mixed with a relatively large amount of a relatively cold oxygen-rich stream from water electrolysis at the inlet of the burner, the tail gas in the invention needs to be heated to relatively lower temperature, permitting better heat recovery.

Preferably, the process gas is supplied from the burner section to the absorption section through a cooling section and a condensation section, as discussed hereinafter. Preferably said O₂ is introduced into the process gas stream between the condensation section and the tail gas outlet of the absorption section, preferably between a gas outlet of the condensation section and the tail gas outlet of the absorption section. This provides the advantage that the cooling section and preferably also condensation section can be smaller.

Preferably, the absorption section is an absorption column and the absorption section O₂ feed is supplied to the bottom of the absorption column.

The present disclosure provides a nitric acid production method and a nitric acid plant. The plant is preferably suitable for performing the method. The method is preferably carried out in the plant. The process and plant are generally based on the Ostwald process for nitric acid production. The method comprises supplying an NH₃ feed stream to a burner section and reacting NH₃ and O₂ according to reaction (I) in the burner section to form a process gas stream. The process gas comprises NOx.

The ammonia oxidation reaction (I) is highly exothermic and is typically catalysed by a suitable catalyst. Suitable catalysts are disclosed in Ullmann's Nitric Acid, para. 1.3.1. For example, the catalyst comprises Pt, optionally with Rh or Pd.

The ammonia oxidation reaction is for example performed at a pressure of 3-15 bar and for example at a temperature of at least 800° C., e.g. in the range of 850-950° C.

In practice, N₂O and N₂ are generally formed as by-products of the ammonia oxidation. After formation, N₂ does not take part in any further reactions and is therefore considered an inert, which can accumulate in the system if not purged. A gas stream comprising N₂ is circulated in the process, in particular through the loop burner section-absorption section (e.g., through the loop burner-cooler-condenser-absorber), for instance with a molar ratio N₂:O₂ of about 4:1 at the inlet of the burner section, e.g. with a molar ratio similar to air. The N₂ present in the burner serves as a diluent in the burner to ensure safe operation. Suitably, a gas stream comprising N₂, e.g. with at least 70 vol. % N₂, for instance an air stream, is introduced to the plant during the start-up, e.g. with a start-up air compressor, to supply an amount of N₂ circulating in the plant during the process.

Preferably, the tail gas stream and/or the NH₃ feed, preferably both, are heated in a heater, arranged between the tail gas outlet and the burner section, to a temperature of at least 100° C., e.g. in the range of at least 120° C. and/or up to 250° C. The heater is for example a heat exchanger, such as a tube-and-shell heat exchanger, for instance a process-process heat exchanger. The preheating is found to be especially useful for the process with tail gas recycle to the burner by avoiding an undesired reaction of NOx in the tail gas with added feed NH₃ to form ammonium nitrate and ammonium nitrite.

The burner section comprises a burner. The burner advantageously comprises a shell, a space inside the shell, at least one gaseous feed inlet, a burning zone provided inside the space, and an outlet for the process gas stream. Furthermore, at least one catalyst, is provided in the burning zone. Preferably, the catalyst is provided as a fine mesh gauze which is kept in place e.g. on a perforated plate or thin wire mesh. The perforated plate or wire mesh is designed to provide support to keep the catalyst gauze in place, while providing a minimum pressure drop. Preferably, a catalyst recovery system is provided downstream of the burner section.

In an example embodiment, the burner comprises a mixing zone provided in the space of said burner upstream of the burning zone. In this embodiment the burner comprises at least two inlets, e.g. an inlet for the tail gas stream and a separate inlet NH₃ feed.

In another example embodiment, the mixing zone is provided as a separate unit, a mixer, between the tail gas purge outlet and the burner. In this embodiment the mixer comprises an inlet for the tail gas and a separate inlet NH₃ feed and an outlet for a mixed tail gas and NH₃ stream in fluid connection with a single gaseous feed inlet of the burner.

The mixing zone comprises for example a perforated plate or a honeycomb grid to improve mixing and distribution of the gaseous feed stream provided over the cross section of the burning zone. Advantageously, the mixing zone is arranged between a tail gas purge outlet and the burning zone to improve safety of the process by limiting the risk of explosion due to local ammonia concentration inhomogeneities. Furthermore, improved mixing achieved by the mixing zone may increase the conversion of NH₃ to NO and reduce loss of the catalyst.

The space of the burner comprises, for example, a filling material to ensure a uniform distribution of the reaction mixture.

The process gas stream (i.e. the process gas exiting the burner section) is typically cooled to give a cooled process gas stream. Preferably, the process gas stream is cooled to a temperature below 500° C., e.g. in the range of 80-450° C., e.g. at the inlet of the condensation section.

The process gas stream is usually cooled down in a cooling section in one or more cooling steps. Preferably the process gas stream is cooled in a heat exchanging regime with at least one cooling medium in at least one heat exchanger. The cooling section typically comprises multiple heat exchangers in series for cooling the process gas stream. One or more of these heat exchangers may be integrated in the same apparatus as the burner; one or more of these heat exchangers may also be integrated in the same apparatus as the condenser.

In a preferred embodiment, the cooling section comprises a waste heat boiler, a tail gas heater, and/or a boiler feed water heater in series; optionally with further heat exchangers in series. In one embodiment the waste heat boiler, tail gas heater and boiler feed water are provided in series in this order. These units are heat exchangers used as coolers for the process gas stream. The waste heat boiler may comprise multiple heat exchangers in series, such as a superheater and an evaporator. Preferably, these units are provided in series for cooling the process gas stream. Preferably, the waste heat boiler, an economizer, the tail gas heater, and the boiler feed water heater are each independently provided as a shell-and-tube heat exchanger comprising a tube side and a shell side. The waste heat boiler is preferably operated with the process gas stream in the tubes and boiler feed water in the shell side. The tail gas heater is preferably operated with tail gas to be heated on one side and the process gas stream on the other side, preferably with the process gas stream in the tubes. The boiler feed water heater is preferably operated with process gas in the tubes and the boiler feed water in the shell. The tubes may for example extend through the channel for the process gas. One or more of these heat exchangers may also be provided with a different construction, e.g. as heat exchanger in the wall of the burner section.

More preferably, the process gas stream is subsequently provided through the waste heat boiler, the economizer, the tail gas heater, and the boiler feed water heater.

Advantageously, the process gas stream is partially condensed in the cooling section before entering a condensation section. An initial condensate comprises, for example, condensed water vapours, and possibly a minor amount of nitric acid. The cooling section comprises, in particular for a mono pressure process, usually, no gas/liquid separation unit on the process side.

The cooled process gas stream is usually subjected to condensation, which term includes further condensation, in the condensation section to form a condensate and a non-condensed process gas stream. In particular at least some water vapor is condensed from the cooled gas stream in the condensation section.

Accordingly, in the condensation section the cooled gas stream is condensed to provide a liquid stream, i.e. the condensate, and a gaseous stream, i.e. the non-condensed process gas stream. Throughout this application, this non-condensed process gas stream is still designated process gas.

Typically, not exclusively, the gas stream and liquid stream are separated from each other by gas/liquid separation, and supplied as separate streams to the absorption section. This advantageously allows for more efficient treatment of each stream in the absorption section. In this embodiment, the gas flow line for the non-condensed gas is part of the gas flow line from the gas outlet of the burner section and the tail gas outlet of the absorption section. In the alternative embodiment without gas/liquid separation, the fluid connection between de condensation section and the absorption section is a part of the gas flow line from the gas outlet of the burner section and the tail gas outlet of the absorption section.

Preferably, the cooled process gas stream is cooled further in the condensation section. More preferably, the cooled process gas stream is cooled to a temperature below 70° C., e.g. in the range of 5-50° C. in the condensation section, for example with heat exchange against cooling water.

The condensation section comprises a heat exchanger comprising a cooled gas stream inlet, a cooling fluid inlet, a non-condensed stream outlet, a condensate outlet, and a cooling fluid outlet. Preferably, the condensation section comprises a condenser that is a shell-and-tube heat exchanger. Preferably, the cooled gas stream is subjected to condensation in a shell side of the gas-cooler condenser to give the non-condensed gas stream and the condensate, while a cooling liquid, for instance cooling water, is provided in tubes.

Optionally, the cooling section and the condensation section, entirely or in part, are provided as a single unit. Alternatively, the cooling section and the condensation section are provided as separate units.

The process gas, e.g. the non-condensed gas stream, comprising nitrogen oxides (NOx) is supplied to the absorption section. In the absorption section, the gas stream is absorbed in the aqueous absorption liquid to form nitric acid by reactions (III) and (IV). The inert N₂ component of the gas stream leaves the absorption section as the tail gas stream, containing a slip of NOx that is desirably as low as possible. For these purposes, it is important that a large part of the NO that is formed by reaction (III) in the absorber, is reacted away inside the absorption section.

In the absorber of a nitric acid production process, NO gas is formed during the formation of nitric acid (reaction IV), which NO is subsequently oxidized to NO₂ and/or N₂O₄ (reaction II), and converted to nitric acid by reactions (reaction IV and V) in the same absorber. This provides a unique aspect of the Ostwald process, compared to absorbers in general.

In the inventive process, the NO formed in the absorption section, is reacted with O₂ in the absorption section to form NO₂ according to reaction IV; the formed NO₂ is absorbed still in the absorber. The reactor may require a sufficient number of trays to let the NO oxidation proceed to sufficient extent and to absorb the resulting NO₂. In the invention, very advantageously a relatively large amount of O₂ is supplied to the absorption section. This was found to improve the operation of the absorption section, in particular to permit a shorter absorption column, or for a fixed equipment size, lower concentration of NOx at the outlet of the absorption column and/or lower total pressure.

Preferably, the aqueous liquid is in counter-current contact with the process gas, e.g. non-condensed gas stream, in the absorption section. Preferably, the process gas has a temperature below 90° C., e.g. in the range of from 5° C. and/or e.g. up to −70° C. at an inlet of the absorption section.

The absorption section is provided with at least one inlet for the process gas, an inlet for the aqueous liquid, an outlet for the nitric acid liquid stream, and an outlet for the tail gas stream. In an embodiment, the absorption section is provided with an inlet for the process gas and a separate inlet for the O₂ feed. The separate inlet is for instance connected with a gas outlet of the bleaching section.

In a conventional nitric acid plant, the oxidation of NO in the absorber uses oxygen originating from the process gas stream. The oxygen content of the gas phase from the condenser is typically relatively low; the same applies for the gas phase in the absorption section.

In the inventive process, the O₂ level of the gas phase in the absorption section is higher; moreover a relatively large molar amount O₂ is supplied to the absorption column. Accordingly, this yields a higher oxidation and/or absorption rate compared to the conventional process due to the higher partial pressure of O₂ in the absorber. Advantageously a relatively short absorption column can be used in the absorption step of the process while the concentration of NOx in the tail gas stream is maintained at a very low level, for example below 400 ppm or e.g. below 200 ppm (vol.).

Preferably, the absorption section further comprises an inlet for the condensate, separate from the gas inlet(s). In operation, the condensate comprising diluted nitric acid solution is supplied to the absorption section as a separate liquid stream. In this preferred embodiment, the concentration of nitric acid in the condensate increases in the absorption section. Preferably the condensate is supplied to the absorption section at a position above the position where the non-condensed gas is fed to the absorption section.

Preferably, the absorption section is provided as an absorber. More preferably, the absorber is an absorption column. In the absorption column, the inlet for the process gas stream and the inlet for the absorption section O₂ feed, optionally as separate inlets or as a combined inlet, and the nitric acid outlet are provided in a bottom part of the column, and the inlet for the aqueous liquid and the outlet for the tail gas stream in a top part of the absorption column. Preferably, the absorption column is provided with the condensate inlet higher than the non-condensed gas inlet, more preferably the condensate inlet is provided in the middle part of the absorption column.

Preferably, the absorption column is a tubular vertical vessel comprising horizontal trays, also referred to as plates. Preferably, one or more of the trays are provided with cooling coils. Generally, the vertical spacing between the trays increases from bottom to top.

In operation, typically a liquid layer is maintained on the trays (plates) with gas bubbling up. Liquid flows down through downcomers from tray to tray; gas flows up through perforations in the trays.

The tail gas comprises unreacted NOx, N₂ and N₂O side products. A part, preferably at least 90 vol. %, of the tail gas stream is recycled to the burner section, e.g. at least 95 vol. %; and typically less than 99.99 vol. %. Recycling of the tail gas stream to the burner section advantageously allows for recycle of N₂ diluent and for providing excess O₂ in the absorber where it reacts with NOx after which the remaining O₂ is recycled to the burner with the correct amount of O₂ for the ammonia oxidation reaction. Moreover, the tail gas recycle provides for decomposition of N₂O by-product in the burner section thereby reducing N₂O emissions.

Suitably, the tail gas is subjected to demisting before it exits the absorption section to collect droplets entrained in the tail gas stream. Suitably, the tail gas stream is supplied to a recycle blower. In the recycle blower, the tail gas stream is compressed to the burner section pressure to give a compressed tail gas stream. Hence, generally, suitably a fan is used to drive the gas flow to the burner.

Preferably, the tail gas stream is heated in the tail gas heater to give a heated tail gas stream. More preferably, the tail gas stream is heated by at least 30° C. or at least 100° C., but preferably still to a temperature below 250° C., e.g. in the range of 180-220° C. in the tail gas heater. The tail gas heater preferably operates by indirect heat exchange against the process gas stream.

Preferably, the part of the tail gas stream which is subjected to recycling is, after the heating, mixed with the NH₃ feed and supplied to the burner.

Preferably, a part of the tail gas stream which is not subjected to recycling, e.g. in an amount of less than 5 vol. %, or less than 2 vol. %, typically at least 0.10 vol. % of the tail gas, is purged, to avoid the accumulation of N₂. The purged tail gas is suitably supplied to an abatement system to reduce the amount of N₂O and NOx in said part of the tail gas stream to give a purge stream which is e.g. released into the environment. In the abatement system N₂O and NOx are for example catalytically converted to N₂.

The process involves for example, supplying an NH₃ feed stream to a burner section, reacting NH₃ and O₂ in the burner section to form a process gas stream, cooling the process gas stream in a cooling section to give a cooled gas stream and subjecting the cooled gas stream to condensation in a condensation section to form a condensate and a non-condensed process gas stream, supplying the non-condensed process gas stream to an absorption section, wherein the absorption section operates preferably at a pressure lower than or equal to the pressure of said burner section, contacting the non-condensed process gas stream with an aqueous liquid in the absorption section to form a nitric acid stream and a tail gas stream, and recycling the tail gas stream for at least 90 vol. % to the burner section, and introducing the absorption section O₂ feed to the process gas stream, cooled gas stream, non-condensed process gas stream, and/or into the absorption section. Combining (a part of) the absorption section O₂ feed with the condensate is also possible.

In a preferred embodiment, the nitric acid stream from the absorption section is provided to a bleaching section. In particular the raw nitric acid stream from the absorption section, comprising nitrous acid and residual NOx, is provided to the bleaching section. The bleaching section comprises an inlet for a bleacher gas feed, preferably a bleacher O₂ feed, an inlet for the nitric acid stream from the absorption section, an outlet for a bleached nitric acid stream, and an outlet for a gas stream from the bleaching section.

In an example embodiment, the bleaching section is a unit or compartment comprising a shell and a space inside the shell, an inlet for bleacher gas feed, preferably bleacher O₂ feed in a bottom part, an inlet for nitric acid from the absorption section in a top part, an outlet for the bleached nitric acid stream in the bottom part, and an outlet for a gas stream from the bleaching section. An example bleaching section further comprises a packing and/or trays, and for instance a distribution tray in an upper part of the space of the bleaching section with the packing material or trays below the distribution tray. The distribution tray delivers the nitric acid stream to the packing material or trays.

In operation, the nitric acid stream from the absorption section is provided to the packing material and/or trays in the bleaching section, thereby increasing the relative surface area of the nitric acid stream, and said nitric acid stream is subjected to a counter-current flow of the bleacher gas feed, preferably the bleacher O₂ feed, to strip out the gases, such as for instance NOx, dissolved and/or entrained in said nitric acid stream. Additionally, nitrous acid contained in the liquid stream is further oxidized to nitric acid in the bleaching section.

The bleaching section is e.g. a separate unit, or e.g. a compartment located in a bottom part of the absorption column. The bleaching section is can also be provided as a bleaching zone by trays arranged in a bottom part of the absorption column, e.g. trays provided below the inlet for process gas of the absorption column. The latter option is in particular useful for a mono pressure process.

Background references for mono pressure nitric acid plant with the bleacher integrated in the absorption column include the article R. Maurer, New Technological Concept for Nitric Acid: The Compact Nitric Acid Plant, and the brochure Nitric acid—a true all-rounder of ThyssenKrupp Industrial Solutions, http://www.thyssenkrupp-industrial-solutions-rus.com/assets/pdf/TKIS_Nitric_Acid.pdf. A further reference for a mono pressure nitric acid plant with the bleacher integrated at the bottom of the absorption column is “The Compact Plant”, Nitrogen May-June 1995, p. 32-33.

The bleaching section typically selectively receives liquid from the absorption section and no process gas stream from the absorption section. The term ‘bleacher’ as used herein includes such a bleaching section integrated in the absorption column. The bleaching section is e.g. operated at the same pressure as the absorption column, or e.g. at a lower pressure.

In a preferred embodiment, a gas stream from the bleaching section is provided to the absorption section; preferably at least 90 vol. % or even all gas from the bleaching section is supplied to the absorption section.

In a preferred embodiment, the nitric acid stream from the absorption section is supplied to a bleaching section, a bleacher O₂ feed is supplied to the bleaching section, and a gas stream from the bleaching section is supplied to the absorption section. Preferably the bleacher O₂ feed has an O₂ concentration of at least 90 vol. % O₂ and/or contains less than 10 vol. % N₂. Preferably the bleacher O₂ feed contains O₂ in a molar ratio to the NH₃ feed stream of at least 1.0 (O₂:NH₃); preferably at least 1.20, or at least 1.50, or at least 1.90, i.e. based on molar flow rate (mol/hour). Preferably the bleaching section receives an oxygen stream with at least 90 vol. % O₂, or at least 95 vol. % O₂, or even at least 99 vol. % O₂. Preferably, the amount of O₂ supplied with such a high purity to the bleaching section corresponds to a molar ratio with the NH₃ feed, or the amount of NH₃ reacted into nitric acid, of at least 1.0, or at least 1.2, or at least 1.5, or at least 1.9; and typically up to 2.0.

In addition or alternatively, preferably an amount of oxygen corresponding to at least 50 vol. %, at least 90 vol. % or at least 95 vol. % or at least 99 vol. % of the total amount of O₂ received by the burner, or introduced into the nitric acid plant in total, is supplied to the bleaching section, more preferably with a purity of at least 90 vol. %, at least 95 vol. % or at least 99 vol. %.

Preferably, a gas stream from the bleaching section is supplied to the absorption section. Preferably at least 50 vol. % or at least 90 vol. % of the gas from the bleaching section is supplied to the absorption section, to provide for a part or all of the absorption section O₂ feed, optionally through the gas flow line for process gas, in particular for non-condensed gas, or directly to the absorption section, in particular to the absorption section bottom. Typically, the gas stream from the bleaching section comprises at least 90 vol. % O₂ or at least 95 vol. % O₂. Thereby advantageously, the O₂ feed is preferably used simultaneously for stripping the nitric acid stream in the bleaching section to remove dissolved NOx, oxidation of the nitrous acid to nitric acid in the bleaching section, oxidation of NO in the absorption section and in the bleaching section, and oxidation of ammonia in the burner section. The relatively high amount of O₂ in the bleaching section may contribute to the stripping of NOx which is based on a counter-current contact between the liquid containing dissolved NOx and a gas stream with a low partial pressure of NOx. Hence, a sufficient volumetric flow of strip gas is advantageous, the strip gas having a relatively high O₂ concentration in the invention. In some embodiments, the entire amount of O₂ reactant for the process is supplied through the bleaching section.

Advantageously, providing an O₂ feed with high oxygen purity and a large amount of oxygen (mol/hr) to the bleaching section allows for increasing the stripping of dissolved NOx and oxidation of nitrous acid.

The absorption section O₂ feed is preferably supplied as one or more gas streams which originate from an NH₃ production unit operating with H₂O electrolysis. Preferably, the absorption section O₂ feed is provided by a O₂ gas stream from a H₂O electrolysis unit and/or as an O₂ gas stream from an air separation unit (ASU); more preferably from both. Providing the absorption section O₂ feed by both the O₂ gas stream from the H₂O electrolysis unit and the O₂ gas stream from the air separation unit (ASU) a relatively large amount of O₂ can be supplied to the absorption section.

Preferably, the NH₃ feed is supplied to the burner section as an NH₃ gas stream from an NH₃ production unit, wherein the NH₃ synthesis in said unit utilizes a H₂ gas stream from the H₂O electrolysis unit and a N₂ gas stream from the air separation unit. The H₂O electrolysis unit may operate with liquid or gaseous H₂O. Preferably the entire NH₃ feed of the burner originates from the NH₃ production unit. Optionally, some but not all NH₃ formed in the NH₃ production unit is supplied to the burner. Optionally, some but not all N₂ generated in the ASU is supplied to the NH₃ synthesis. The use of electrolysis compared to steam methane reforming for H₂ production can advantageously provide for lower CO2 emissions.

The invention also pertains to a nitric acid plant. The plant is preferably suitable for the inventive process. The inventive process is preferably carried out in the plant. Preferences for the units and plant used in the process apply equally for the plant. Preferences for the plant apply equally for the process carried out in the plant.

The plant comprises a nitric acid production section and an ammonia production section. The nitric acid production section comprises a burners section and an absorption section. The burner section comprises an inlet for an NH₃ feed, an inlet for a tail gas stream and an outlet for a process gas stream. The absorption section comprises an inlet connected to receive gas from the outlet for the process gas stream of the burner section, an inlet for an aqueous liquid, an outlet for the tail gas stream, and an outlet for a nitric acid stream. The ammonia production section comprises a H₂O electrolysis unit, an air separation unit and an ammonia production unit. The H₂O electrolysis unit comprises an inlet for a H₂O stream, a first outlet for a first O₂ stream and an outlet for a H₂ stream. The H₂O is e.g. liquid water and/or steam. The air separation unit comprises an inlet for an air stream, a second outlet for a second O₂ stream and an outlet for a N₂ stream. The ammonia production unit comprises an inlet for the H₂ stream in fluid connection with the outlet for H₂ stream from the H₂O electrolysis unit, an inlet for N₂ stream in fluid connection with the outlet for the N₂ stream from the air separation unit, and an outlet for an NH₃ stream. The plant, in particular the nitric acid production section, comprises a first gas flow line from the outlet of the burner section for the process gas stream to the outlet absorption section for the tail gas stream. The first outlet for the first O₂ stream of the H₂O electrolysis unit and the second outlet for the second O₂ stream of the air separation unit are both connected to the first gas flow line. The first gas flow line passes through the absorption section to the tail gas outlet of the absorption section.

For example, the plant comprises a gas flowline from the first outlet for the first O₂ stream of the H₂O electrolysis unit to the absorption section and a gas flow line from the second outlet for the second O₂ stream of the air separation unit to the absorption section; these gas flow lines be separate or combined.

The plant typically comprises a cooling section, comprising an inlet connected to the outlet of the burner section for the process gas stream, and an outlet for a cooled gas stream. The plant typically comprises a condensation section comprising an inlet for the cooled gas stream, an outlet for a non-condensed gas stream connected with the gas inlet of the absorption section, and an outlet for a condensate. The first gas flow line typically passes through the cooling section and the condensation section. Preferably, the first outlet for the first O₂ stream of the H₂O electrolysis unit and the second outlet for the second O₂ stream of the air separation unit are both connected to the first gas flow line between an outlet of the condensation section and the tail gas outlet.

The plant preferably comprises a bleaching section that comprises an inlet for the nitric acid stream, an inlet for a bleacher O₂ feed, an outlet for a gas stream from the bleaching section in fluid connection with the absorption section, and an outlet for a bleached nitric acid stream. The bleaching section is connected to receive gas from the first outlet for the first O₂ stream and the second outlet for the second O₂ stream. Preferably the bleaching section and the absorption section are integrated in a single vessel.

The invention also pertains to a method of modifying an existing nitric acid plant, wherein the existing nitric acid plant comprises a nitric acid production section and an ammonia production section. The nitric acid production section comprises a burner section, and an absorption section. Preferences and details for these units are the same as for the inventive plant. The ammonia production section comprises or is modified as part of the method to comprise a H₂O electrolysis unit, an air separation unit, and an ammonia production unit. Preferences and details for these units are the same as for the inventive plant.

The existing plant, in particular the nitric acid production section, comprises a first gas flow line from the outlet of the burner section for the process gas stream to the outlet for the tail gas stream. Preferences and details for this gas flow line are as for the process and plant. The method involves the step of connecting both the first outlet for the first O₂ stream and the second outlet for the second O₂ stream to the first gas flow line. The modified plant is preferably an inventive plant as described. The method for example involves adding a gas flow line from the first outlet for the first O₂ stream to the first gas flow line; and adding a gas flow line from the second outlet for the second O₂ stream to the first gas flow line. These gas flow lines can be added as separate lines or as combined line. The added gas flow line are for instance configure to introduce the O₂ into the absorption section.

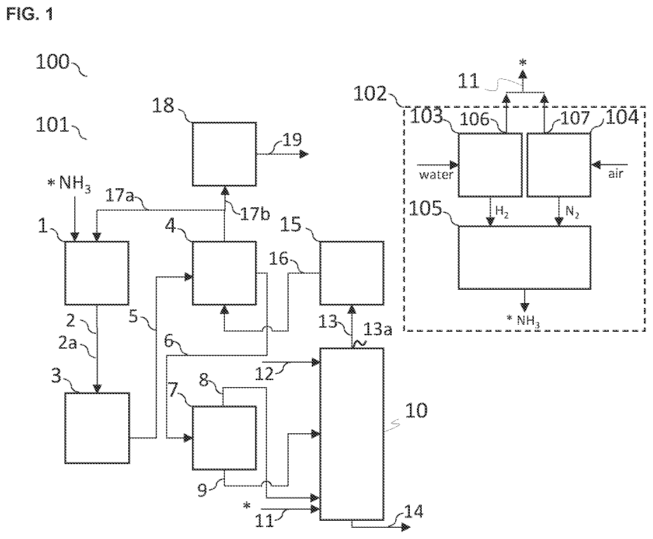

FIG. 1 schematically illustrates an example nitric acid plant and process according to the invention. The nitric acid production plant (100) comprises the nitric acid production section (101). The nitric acid production section (101) comprises a burner section (1), a cooling section (3), a condensation section (7), an absorption section (10), an optional recycle blower (15), and an optional abatement system (18).

The burner section (1) is preferably a burner. The burner comprises a shell, a space inside the shell, an inlet for a NH₃ feed, an inlet for a heated tail gas stream (17), and an outlet for a process gas stream (2).

The burner further comprises a reaction zone and at least one catalyst is supported on a catalyst support bed inside the space of said burner. Preferably, the NH₃ feed and the heated tail gas stream (17) are supplied to the burner section (1) as heated streams. Optionally, the burner section (1) comprises a mixer or a burner head suitable for mixing of the NH₃ feed and the heated tail gas stream (17) upstream of, or as a part of, the burner.

In operation, the NH₃ feed and the heated tail gas stream (17) are subjected to the catalysed ammonia oxidation reaction (I) to give the process gas stream (2) comprising NO and water vapour.

The process gas stream (2) is provided to the cooling section (3). In an example embodiment, the cooling section (3) comprises a waste heat boiler, a tail gas heater (4), and a boiler feed water heater. In the figure, the gas flow line (2a) from the gas outlet of the burner section (1) to the tail gas outlet (13a) of the absorption section is provided the combination of gas flow lines and units 2, 3, 5, 4, 6, 7, 8 and 10. The cooling section (3) and condensation section (7) are preferred sections.

The cooled gas stream (5) from the cooling section (3) is provided to the condensation section (7). In a preferred embodiment shown in FIG. 1 the cooled gas stream (5) is provided to an optional tail gas heater (4) to give a further cooled gas stream (6) supplied to the condensation section (7).

The condensation section (7) comprises an inlet for the cooled gas stream (5) or further cooled gas stream (6), an outlet for a non-condensed gas stream (8) and an outlet for a condensate (9). The condensation section is preferably a heat exchanger, for example a shell-and-tube heat exchanger, more preferably a condenser or a gas cooler-condenser.

In operation, the cooled gas stream (5) and/or further cooled gas stream (6) is further condensed in said condensation section (7). In the condensation section (7), a part of NO oxidises to nitrogen oxides, in particular NO₂, in the gas phase according to the reaction scheme (II). Nitric acid is formed according to the reaction schemes (III) and (IV) which is present in the condensate (9) as nitric acid aqueous solution.

Optionally, the condensation section (7) further comprises an inlet for absorption section O₂ feed (not shown) or, in another optional embodiment, an O₂ feed line and the non-condensed stream feed line (8) are combined prior to entering the absorption section (10) (not shown).

The absorption section (10) comprises an inlet for the non-condensed gas stream (8), an inlet for an aqueous liquid (12), an inlet for the absorption section O₂ feed (11), an outlet (13a) for a tail gas stream (13) and an outlet for nitric acid stream (14). Preferably, the absorption section (10) further comprises an inlet for the condensate (9). Optionally, the absorption section O₂ feed (11) can be provided prior to the absorption section (10), for example said absorption section O₂ feed (11) can be mixed with the non-condensed gas stream (8) upstream of said absorption section (10). Generally, the absorption section (10) is for example, an absorber or an absorption column. The inlet for the non-condensed gas stream (8) and the inlet for the absorption section O₂ feed (11) and the outlet for the nitric acid stream (14) are provided in a bottom part of the absorber and the inlet for the aqueous liquid (12) and the outlet for the tail gas stream (13) are provided in a top part of the absorber. If the inlet for the condensate is provided in the absorber, it is provided in the middle part of said absorber. In alternative embodiments, the absorption section O₂ feed (11) is supplied, for example, to flow line 2, flow line 5, flow line 6, or flow line 8, or to unit 3, or unit 4, or unit 7, or to unit 10. In principle the absorption section O₂ feed (11) can in part also be supplied to flow line 9. Combinations thereof are also possible, also with supplying a part of the absorption section O₂ feed (11) to the absorption column (10). The absorption section O₂ feed (11) can also be introduced at multiple points in the absorption column (10).

Preferably, a part or all of the absorption section O₂ feed (11) originates from a H₂O electrolysis unit (103) and/or an air separation unit (104); preferably from both. Advantageously, an ammonia production section (102) comprises the H₂O electrolysis unit (103), the air separation unit (104) and an ammonia production unit (105).

The H₂O electrolysis unit (103) comprises a water inlet, an O₂ stream outlet (106) and a H₂ stream outlet. In operation, water (liquid or gas) is supplied to the H₂O electrolysis unit (103), to produce an O₂ stream and H₂ stream; H₂ stream is advantageously supplied to the ammonia production unit (105) and the O₂ stream (106) is advantageously supplied to the nitric acid production section (100) as all or a part of the O₂ feed (11). Hence, the O₂ stream outlet (106) is connected to introduce gas into the gas flow line (2a).

The air separation unit (104) comprises an air inlet, an O₂ stream outlet (107) and a N₂ stream outlet; and an ammonia production unit (105) comprises a N₂ stream inlet, a H₂ stream inlet and a NH₃ stream outlet. In operation, air is supplied the air separation unit (104), to produce an O₂ stream (107) and N₂ stream; N₂ stream is advantageously supplied to the ammonia production unit (105) and the O₂ stream is advantageously supplied to the nitric acid production section (100) as all or a part of the O₂ feed (11). Hence, the O₂ stream outlet (107) is connected to introduce gas into the gas flow line (2a)

The N₂ stream comprises more than 80 vol. % N₂, e.g. at least 90 vol. % or at least 99 vol. %. In the ammonia production unit (105) the N₂ stream and H₂ stream are reacted to form an NH₃ stream, which is advantageously supplied to the burner section (1).

The tail gas stream (13) from the absorption section (10) is supplied to the recycle blower (15). The tail gas stream (13) comprises N₂ and unreacted NOx, and N₂O side product. Generally, the recycle blower is a compressor. In operation the tail gas stream (13) is compressed in the recycle blower (15) to the burner section pressure to give a compressed tail gas stream (16). The compressed tail gas stream (16) is then supplied to the tail gas heater (4) to give a heated tail gas stream (17). A first part (17a) is supplied to the to the burner section (1), e.g. at least 90 vol. %, or at least 95 vol. %; and a second part (17b), e.g. 0.1-2.5 vol. %, is supplied to the abatement system (18) to reduce the content of N₂O and NOx present in said gas stream before releasing a purge stream (19) e.g. to the environment.

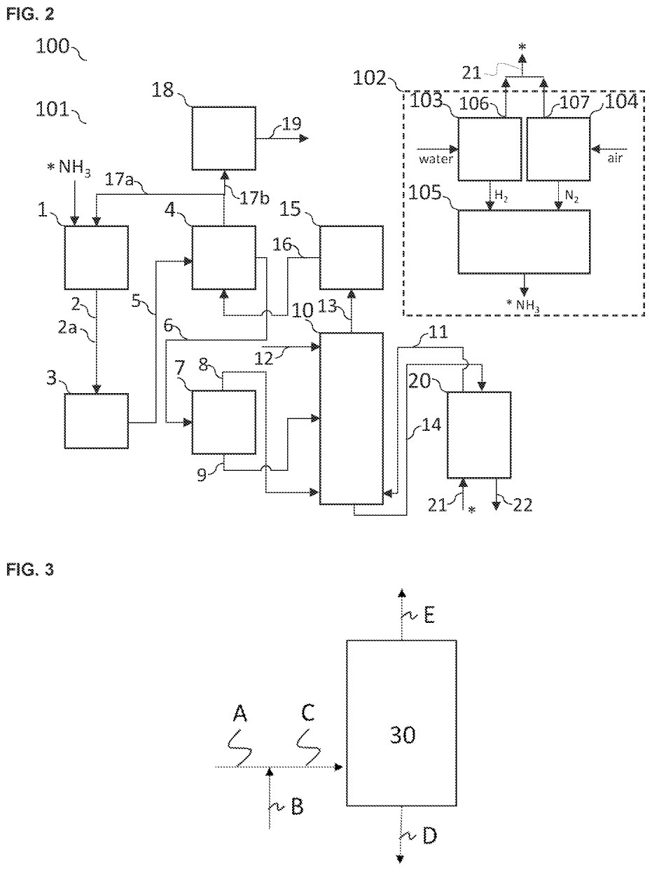

FIG. 2 illustrates an embodiment wherein the O₂ feed (11) is provided to the absorption section (10) from a bleaching section (20). The bleaching section (20) is preferably a bleacher. The bleacher comprises a shell, a space inside the shell, an inlet for the nitric acid stream (14), and an outlet in an upper part of the bleacher for a gas stream that is the absorption section O₂ feed (11), and an inlet for the bleacher O₂ feed (21) and an outlet for a bleached nitric acid stream (22) in a bottom part of said bleacher. Preferably, the bleacher further comprises a distribution tray in the upper part of the space of the bleacher and a packing material below the distribution tray. Optionally, the bleaching section (20) is provided in the same unit as the absorption section (10).

In this embodiment, the absorption section O₂ feed (11) is provided to the absorption section (10) via the bleacher. The nitric acid stream (14) comprises NOx gases dissolved and/or entrained in nitric and nitrous acids aqueous solution. In operation, the nitric acid stream (14) is supplied to the bleacher and contacted with a counter-current flow of the bleacher O₂ feed (21) to strip out the gases, such as for instance NOx, dissolved and/or entrained in said nitric and nitrous acids stream (14) to give the bleached nitric acid stream (22). Additionally, nitrous acid is further oxidized to nitric acid in the bleacher. Preferably

Pressures are absolute pressures unless indicated otherwise.

The terms ‘typically’, ‘generally’, and ‘preferably’ and derived forms indicate non-mandatory features.

Preferably the nitric acid production process is carried out in the inventive nitric acid plant. Preferably the plant is suitable for the inventive process. All preferences for the nitric acid production process apply equally for the nitric acid plant. All preferences and details indicated for equipment parts in connection with the nitric acid production process, apply equally for the nitric acid plant.

### EXAMPLES

The invention will now be further illustrated by the following non-limiting example(s). These examples do not limit the invention and do not limit the claims.

### Example 1

A reference nitric acid production process using primary and secondary air (Process C) and an inventive nitric acid production process (Process 1) were simulated. In comparative Process C, the primary air was supplied to the burner, the secondary air to the absorber, and no tail gas was recycled. All tail gas was vented after a suitable tail gas treatment to remove NOx. The inventive Process 1 was generally according to FIG. 1. Both processes were mono pressure processes operated at a pressure in the range 5-15 bar absolute.

As shown in FIG. 3, in both processes a gas stream (C) is supplied to the absorption tower (30). Gas stream (C) is obtained by combining the process gas stream (A) originating from the burner with a stream (B). The absorption tower yields liquid nitric acid product (D) and the tail gas (E). The gas compositions of A and C are shown in Table 1 and for gas streams B, D, and E in Table 2 below (with ton=1000 kg). In both processes, the NH₃ feed was 224 kmol/h and the nitric acid production was 215 kmol/h. The molar ratio of O₂ in stream B to NH₃ feed was 2.04 in Process 1 and 0.38 in Process C. In process 1, about 9% of the O₂ in stream B is reacted in the absorption tower (14.0 ton/hr O₂ supplied in B and 12.8 ton/hr is still present in stream E).

The number of trays in the absorption tower could be reduced by about 45% in the inventive Process 1 compared to Process C while achieving the desired low NOx content of the tail gas of <400 ppm vol; in Process 1 the NOx level was even lower than in Process C. The column diameter was kept the same and the volumetric flow rate in the absorption column was similar. The same NOx level at the absorption tower inlet was used with the level in the range of 6-9 vol. %.

The volumetric gas flow rate of gas stream B and of the gas stream that is supplied to the gas inlet of the bleacher was slightly higher in the inventive example Process 1 than in the comparative Process C such that operation of the bleacher is expected to be adequate for both processes.

In the inventive example Process 1, the tail gas contained 21 vol. % O₂, balance essentially N₂ and 225 ppm vol of NOx (NO and NO₂ in total), for advantageous supply to the burner with a small purge.

TABLE 1

| | |
|---|---|
| Process 1 | Comparative Process C |

| Stream | A | C | A | C |
|---|---|---|---|---|
| Total flow | 49.3 | 63.6 | 46.4 | 58.2 |
| ton/h | | | | |
| Total flow | 6.7 | 7.8 | 5.8 | 7.3 |
| 1000 m³/h | | | | |

Mass fractions

| | | | | |
|---|---|---|---|---|
| H2O | 1.0% | 0.8% | 0.6% | 0.6% |
| NO | 1.8% | 0.8% | 2.8% | 0.2% |
| NO2 | 11.0% | 7.4% | 7.0% | 7.4% |
| N2O4 | 1.1% | 3.0% | 2.0% | 3.0% |
| N2 | 85% | 66% | 87% | 85% |
| O2 | 0.9% | 22.0% | 0.0% | 4.0% |

Mole fractions

| | | | | |
|---|---|---|---|---|
| H2O | 1.6% | 1.4% | 1.0% | 0.9% |
| NO | 1.8% | 0.8% | 2.7% | 0.2% |
| NO2 | 6.8% | 4.9% | 4.4% | 4.8% |
| N2O4 | 0.4% | 1.0% | 0.6% | 1.0% |
| N2 | 89% | 71% | 91% | 90% |
| O2 | 0.8% | 21% | 0.0% | 3.3% |
| Physical | Vapor | Vapor | Vapor | Vapor |
| state | | | | |
| Temp. (° C.) | 60 | 60 | 65 | 60 |
| Pressure | 7.5 | 7.5 | 7.6 | 7.5 |
| (bar) | | | | |

TABLE 2

| | Process | | 1 | C |
|---|---|---|---|---|
| D | Flow rate | ton/h | 22.5 | 22.5 |
| | Water | wt. % | 40 | 40 |
| | Nitric acid | wt. % | 60 | 60 |
| B | Flow rate | ton/h | 14.3 | 11.8 |
| | O₂ | wt. % | 98% | 23% |
| | NO₂ | wt. % | 1.2% | 1.1% |
| | N₂ | wt. % | 0.0% | 75% |
| E | Flow rate | ton/h | 54.6 | 50.7 |
| | N₂ | wt. % | 76% | 98% |
| | O₂ | wt. % | 23% | 1.9% |
| | NO | ppm vol | 125 | 269 |
| | NO₂ | ppm vol | 100 | 65 |
| — | NH₃ supply | kmol/h | 224 | 224 |
| | NA produced | kmol/h | 215 | 215 |
| | O₂ feed/NH₃ | molar | 1.95 | 0.38 |
| | supply | ratio | | |
| | O₂ feed/NA | molar | 2.04 | 0.39 |
| | produced | ratio | | |

1. A process for the production of nitric acid comprising:
supplying NH₃ feed to a burner section and reacting NH₃ and O₂ in the burner section to form a process gas stream;
supplying the process gas stream from the burner section to an absorption section and contacting the process gas stream with an aqueous liquid in the absorption section to form a nitric acid stream and a tail gas stream;
supplying at least 90 vol. % of the tail gas stream from a tail gas outlet of the absorption section to the burner section,
wherein O₂ (the absorption section O₂ feed) is introduced into the process gas stream between the burner section and the tail gas outlet of the absorption section in a molar ratio to the NH₃ feed of at least 1.0.

2. The process according to claim 1, wherein N₂ is introduced into the process gas between the burner section and the tail gas outlet of the absorption section in a molar ratio to the NH₃ feed in the range 0-0.2, preferably in the range 0-0.1;
preferably wherein the tail gas stream and process gas stream together form a circulating gas stream and N₂ is introduced into the circulating gas stream in a molar ratio to the NH₃ feed in the range in the range of 0-0.2, preferably in the range 0-0.1.

3. (canceled)

4. The process according to claim 1, wherein the O₂ is introduced as a single gas stream having, or as a plurality of gas streams in total having, a molar ratio to the NH₃ feed of at least 1.0 and containing at least 90 vol. % 02 and/or less than 10 vol. % N₂.

5. The process according to claim 1, wherein the process gas is supplied from the burner section to the absorption section through a cooling section and a condensation section, and wherein said O₂ is introduced into the process gas stream between the condensation section and the tail gas outlet of the absorption section, preferably between a gas outlet of the condensation section and the tail gas outlet of the absorption section.

6. The process according to claim 5, wherein condensate from the condensation section is supplied to the absorption section; wherein preferably the condensate is supplied to the absorption section at a position above the position where the process gas stream is fed to the absorption section.

7. The process according to claim 1, wherein the nitric acid stream from the absorption section is supplied to a bleaching section, a bleacher O₂ feed is supplied to the bleaching section, and a gas stream from the bleaching section is supplied to the absorption section, wherein the bleacher O₂ feed has an O₂ concentration of at least 90 vol. % O₂ and contains O₂ in a molar ratio to said NH3 feed stream of at least 1.0 (O₂:NH₃); preferably at least 1.20, or at least 1.50, or at least 1.90.

8. The process according to claim 7, wherein the absorption section is provided as an absorption column with trays, and the bleaching section is provided as a zone with trays in a bottom part of said absorption column; preferably wherein the bleaching section is provided below the position where the process gas stream is fed to the absorption section.

9. The process according to claim 1, wherein said absorption section O₂ feed is provided from a H₂O electrolysis unit and/or from an air separation unit, preferably through said bleaching section;
preferably wherein said absorption section O₂ feed originates from both the H₂O electrolysis unit and the air separation unit.

10. The process according to claim 1,
wherein the molar ratio of the absorption section O₂ feed to the NH₃ feed is at least 1.50.

11. A nitric acid plant comprising a nitric acid production section and an ammonia production section,
wherein the nitric acid production section comprises:
a burner section comprising an inlet for an NH₃ feed, an inlet for a tail gas stream and an outlet for a process gas stream;
an absorption section comprising an inlet connected to receive gas from the outlet for the process gas stream of the burner section, an inlet for an aqueous liquid, an outlet for the tail gas stream, and an outlet for a nitric acid stream;
wherein the ammonia production section comprises:
a H₂O electrolysis unit comprising an inlet for a H₂O stream, a first outlet for a first O₂ stream and an outlet for a H₂ stream;
an air separation unit comprising an inlet for an air stream, a second outlet for a second O₂ stream and an outlet for an N₂ stream; and
an ammonia production unit comprising an inlet for the H₂ stream in fluid connection with the outlet for the H₂ stream from the H₂O electrolysis unit, an inlet for the N₂ stream in fluid connection with the outlet for N₂ stream from the air separation unit, and an outlet for an NH₃ stream;
the plant comprising a first gas flow line from the outlet of the burner section for the process gas stream to the outlet of the absorption section for the tail gas stream, and
wherein the first outlet for the first O₂ stream and the second outlet for the second O₂ stream are both connected to the first gas flow line.

12. The nitric acid plant of claim 11, further comprising:
a cooling section, comprising an inlet connected to the outlet of the burner section for the process gas stream, and an outlet for a cooled gas stream;
a condensation section comprising an inlet for the cooled gas stream, an outlet for a non-condensed gas stream connected with the gas inlet of the absorption section, and an outlet for a condensate.

13. The nitric acid plant according to claim 11, wherein the nitric acid production section further comprises:
a bleaching section comprising an inlet for the nitric acid stream, an inlet for a bleacher O₂ feed, an outlet for a gas stream from the bleaching section in fluid connection with absorption section, and an outlet for a bleached nitric acid stream; wherein the bleaching section is connected to receive gas from the first outlet for the first O₂ stream and the second outlet for the second O₂ stream.

14. The nitric acid plant according to claim 11, wherein the bleaching section and the absorption section are integrated in a single column or vessel.

15. A method of modifying an existing nitric acid plant, the existing nitric acid plant comprising a nitric acid production section and an ammonia production section,
wherein the nitric acid production section comprises:
a burner section comprising an inlet for an NH3 feed, an inlet for a tail gas stream and an outlet for a process gas stream;
an absorption section comprising an inlet connected to receive gas from the outlet for the process gas stream of the burner section, an inlet for an aqueous liquid, an outlet for the tail gas stream, and an outlet for a nitric acid stream;
wherein the ammonia production section comprises or is modified to comprise:
a H₂O electrolysis unit comprising an inlet for H₂O stream, a first outlet for a first O₂ stream and an outlet for a H₂ stream;
an air separation unit comprising an inlet for air stream, a second outlet for a second O₂ stream and an outlet for a N₂ stream; and
an ammonia production unit comprising an inlet for a H₂ stream in fluid connection with the outlet for the H₂ stream from the H₂O electrolysis unit, an inlet for a N₂ stream in fluid connection with an outlet for the N₂ stream from the air separation unit, and an outlet for an NH₃ stream;
wherein the existing plant comprises a first gas flow line from the outlet of the burner section for the process gas stream to the outlet for the tail gas stream,
wherein the method involves connecting both the first outlet for the first O₂ stream and the second outlet for the second O₂ stream to the first gas flow line; wherein the method preferably provides a plant according to claim 11.

16. A process for the production of nitric acid comprising:
supplying NH₃ feed to a burner section and reacting NH₃ and O₂ in the burner section to form a process gas stream;
supplying the process gas stream from the burner section to an absorption section and contacting the process gas stream with an aqueous liquid in the absorption section to form a nitric acid stream and a tail gas stream;
supplying at least 90 vol. % of the tail gas stream from a tail gas outlet of the absorption section to the burner section,
wherein the tail gas at the tail gas outlet contains O₂ in a molar ratio to the NH₃ feed of at least 1.0, preferably at least 1.20, or at least 1.50, or at least 1.90.
